(19) United States
(12) Patent Application Publication
(10) Pub. No.: US 2011/0037195 A1
(43) Pub. Date: Feb. 17, 2011

(54) Continuous Cast Silicon Strip Apparatus and Method

(76) Inventors: Gregory J. Hildeman, Murrysville, PA (US); Charles E. Bucher, Venetia, PA (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(21) Appl. No.: 12/838,274

(22) Filed: Jul. 16, 2010

Related U.S. Application Data
(60) Provisional application No. 61/226,203, filed on Jul. 16, 2009.

(51) Int. Cl. B29D 7/01

(52) U.S. Cl. 264/212

(57) ABSTRACT

A continuous cast silicon strip apparatus including a drum rotatably mounted on an axle supported by a framework, a motor operatively connected to the axle to cause rotation of the drum about the axle, a crucible mounted relative to the drum to dispense liquid silicon onto a peripheral surface of the drum as the drum rotates to continuously cast a silicon strip onto the peripheral surface and a segmenting mechanism for segmenting the continuous cast silicon strip into silicon segments to a desired length.

### CROSS-REFERENCE TO RELATED APPLICATIONS

This application claims the benefit of provisional patent application, Ser. No. 61/226,203, filed Jul. 16, 2009, the disclosure of which is hereby incorporated by reference herein.

### BACKGROUND OF THE INVENTION

1. Field of the Invention

This invention relates to a method and apparatus for continuous casting of strips of silicon.

2. Description of the Background Art

Presently there exist many methods for continuously casting metal strips, particularly metal strips with an amorphous or crystalline structure, by depositing molten metal onto the moving surface of a chill body by forcing the metal through a slotted nozzle located in close proximity to the surface of the chill body.

More particularly, as set forth in U.S. Pat. No. 4,142,571, the disclosure of which is hereby incorporated by reference herein, a thin uniform layer of molten metal may be mechanically supported on a chill surface to draw out thin metal strips in the form of wires, ribbons and sheets with aspect ratios (width/thickness). The apparatus in U.S. Pat. No. '571 comprises a movable chill body, a slotted nozzle in communication with a reservoir for holding molten metal, and means for effecting expulsion of the molten metal from the reservoir through the nozzle onto the moving chill surface. The movable chill body provides a chill surface for deposition thereon of molten metal for solidification. The chill body is adapted to provide longitudinal movement of the chill surface at velocities in the range of from about 100 to about 2000 meters per minute. The reservoir for holding molten metal includes heating means for maintaining the temperature of the metal above its melting point. The reservoir is in communication with the slotted nozzle for depositing molten metal onto the chill surface. The slotted nozzle is located in close proximity to the chill surface. Its slot is arranged perpendicular to the direction of movement of the chill surface. The slot is defined by a pair of generally parallel lips, a first lip and a second lip, numbered in direction of movement of the chill surface. The slot must have a width, measured in direction of movement of the chill surface, of from about 0.3 to about 1 millimeter. There is no limitation on the length of the slot (measured perpendicular to the direction of movement of the chill surface) other than the practical consideration that the slot should not be longer than the width of the chill surface. The length of the slot determines the width of the strip or sheet being cast. Means for effecting expulsion of the molten metal contained in the reservoir through the nozzle for deposition onto the moving chill surface include pressurization of the reservoir, such as by an inert gas, or utilization of the hydrostatic head of molten metal if the level of metal in the reservoir is located in sufficiently elevated position.

RGS Principle Applied to Silicon

Similar to the process disclosed in U.S. Pat. No. '571, as described in Ribbon-Growth-on-Substrate: Status, Challenges and Promises of High Speed Silicon Wafer Manufacturing, published by A. Schonecker, I. Laas, A Gutjahr, M. Goris, and P. Wyers in the 12^{th} Workshop on Crystalline Silicon Solar Cells, Materials and Processes, the disclosure of which is hereby incorporated by reference herein, Ribbon-On-Substrate (“RGS”) silicon wafer manufacturing technology comprises moving a “cold” (below silicon melting temperature) substrate underneath a casting frame filled with liquid silicon (melting point 1410° C.). Thus, heat is extracted from the silicon melt forcing a crystallization process of silicon from the substrate into the silicon melt. During this process, the substrate is moved underneath the casting frame and crystal growth is stopped at the moment the substrate leaves the casting frame. Thus, crystal growth direction and silicon wafer production direction are perpendicular to each other, which allows the independent control of both. Therefore relatively slow crystal growth can be combined with high substrate transport speed and thus high production volume. After the casting frame, the wafers and the substrates are cooled down. During this process the wafer and the substrate separate, forced by their different thermal expansion coefficients. This allows the substrate to be re-used after the wafer has been picked-up.

Ribbon-Grown-on-Substrate silicon wafer manufacturing technology purportedly was one of the most promising technological developments for the further improvement of silicon wafer based PV modules. Its asserted productivity rate was in the range of 25 MWp, allowing the construction of a 100 MWp wafer production facility with only 2-4 RGS machines. However, no known commercialization of the RGS has actually occurred.

There presently exists a need for improvements to the RGS method and apparatus to materially increase the RGS growth rate from 600 cm/min to about 9,000-18,000 cm/min while reducing the wafer thickness from 0.3-0.4 mm to about 50-200 microns and increasing the purity of the resulting silicon wafers. Further, there exists a need for an improvement to the RGS method to attain a smoother upper surface.

Therefore, it is an object of this invention to provide an improvement which overcomes the aforementioned inadequacies of the prior art devices and provides an improvement which is a significant contribution to the advancement of the art of continuous casting of silicon strips.

### SUMMARY OF THE INVENTION

For the purpose of summarizing this invention, this invention comprises a continuous cast silicon strip (CCSS) apparatus and method that enables high purity silicon strips to be continuously cast to thicknesses below about 100 microns at rotational speeds up to of one revolution per second with a casting speed of about 9,000-18,000 cm/s—equivalent to 34,615-69,230 wafers per hour.

The advantages of the continuous cast silicon strip (CCSS) process include:

High Casting Rate: One CCSS caster has an equivalent output of up to 360 DSS450 casting furnaces.

Low Cost: Eliminates at least 10 major steps currently needed to produce wafers including crucible preparation, charging of crucibles, casting of ingots, removing side plates and broken crucibles cutting bricks, cropping, brick preparation grinding/chamfering/gluing for wire saws, slurry preparation, wire sawing and wafer cleaning. A cost calculation is being developed.

Low Indirect Materials Cost: Significant reduction in the cost of indirect materials by eliminating the need for crucibles, silicon nitride powder, PEG and SiC for slurry as well as epoxy, glass beans and wire for cutting saws.

Low Capital: Significant reduction of capital by eliminating directional solidification furnaces, squarer saws wire saws and supporting equipment.

Low Labor Cost: which can be used in cell processing.

Reduced Flow Time: Flow time to produce wafers is reduced by 10× from 5 days to less than ½ day.

Reduced Silicon per Wafer: Since CCSS strip is cast 80 microns thick there is a 55% reduction of silicon per wafer compared to wafers 180 microns thick.

No Permanent Silicon Kerf Loss: There is not any permanent kerf loss due to wire sawing which is typically 40% of the silicon from bricks. Note: Edge trimming from CCSS silicon strip can be recycled by re-melting.

Surface Smoothness: The upper surface of the strip is considerably smoother than are attainable in prior art methods.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a diagrammatic view of the apparatus of the invention showing the operative arrangement of a crucible positioned above a rotating drum to dispense a continuous strip of silicon onto the peripheral surface thereof.

FIG. 2 is a cross-sectional view of the crucible of the invention with a slotted nozzle.

FIG. 3 is a side elevational view of the cantilever arm to which is mounted the crucible and also an air knife below the cast strip.

FIG. 4 is a diagrammatic view of an improved apparatus of the invention for forming a dual-layer silicon strip showing the operative arrangement of two crucibles positioned above a rotating drum to dispense two continuous strips of silicon, bonded one on top of the other, onto the peripheral surface thereof.

Similar reference characters refer to similar parts throughout the several views of the drawings.

### DETAILED DESCRIPTION OF THE PREFERRED EMBODIMENT

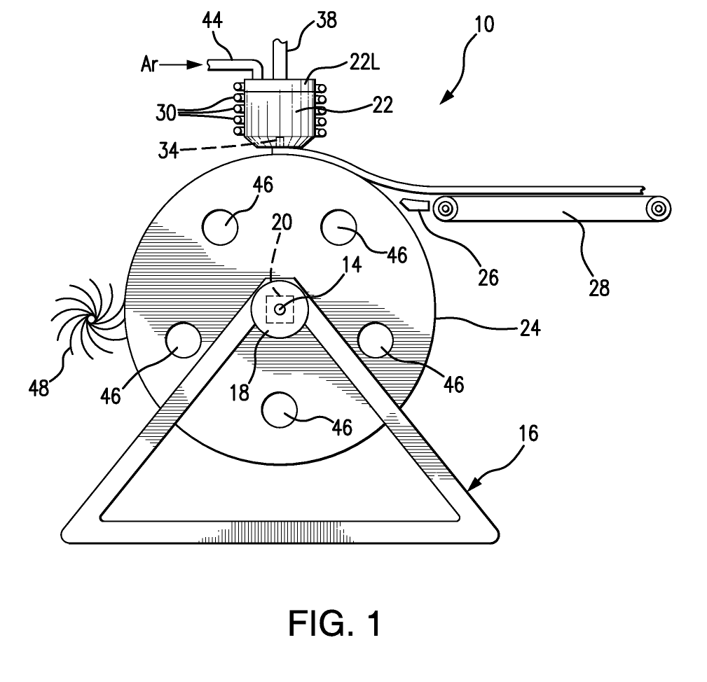

Referring to FIG. 1, the continuous cast silicon strip apparatus and method 10 of the invention comprises a drum 12 rotatably mounted on an axle 14 supported by the framework 16. A motor 18 is operatively connected to the axle 18 by a gearbox 20 to cause rotation of the drum 12 about axle 14. A crucible 22 is mounted above the drum 12 to dispense liquid silicon onto the peripheral surface 24 of the drum 12 as the drum 12 rotates to continuously cast a silicon strip onto the peripheral surface 24. The cast silicon strip is removed from the peripheral surface 24 of the drum 12 further downstream by means of an air knife mechanism 26. It is peeled from the peripheral surface 24 of the drum 12 by the air knife mechanism 26, the continuous cast silicon strip is directed onto a conveyor 28 whereupon the silicon strip may be segmented into silicon segmented having a desired length.

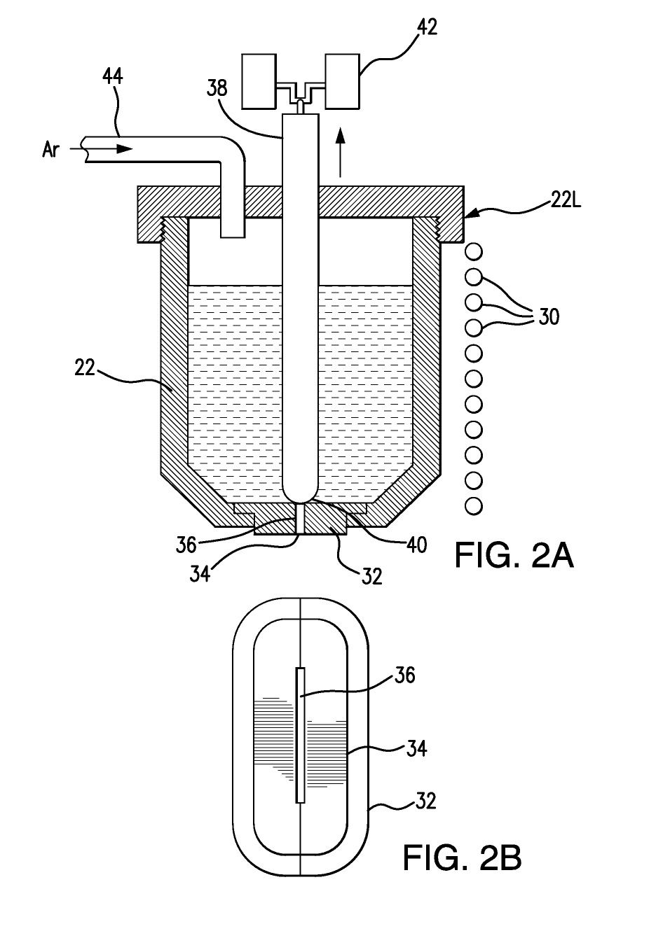

As shown in FIG. 2, the crucible 22 comprises a generally rectangular configuration having the desired interior volume. A lid 22L is fitted about the open end of the crucible 22. An induction heater 30 is formed about the side walls of the crucible 22 to heat the crucible 22 to the desired operating temperature to achieve a desired liquid viscosity of the silicon.

Crucible 22 further comprises a dispenser 32 operatively positioned in the bottommost portion of the crucible 22. In one embodiment, dispenser 32 comprises a nozzle 34 having an elongated slot 36 formed therethrough through which the liquid silicon in the crucible 22 may be dispensed onto the peripheral surface 24 of the rotating drum 12. Flow through the slot 36 may be interrupted by means of a reciprocating stopper rod 38 having a tip appropriately configured and dimensioned to form a seal with the slot 36 to prevent flow therethrough and seated therein. The stopper rod 38 is operatively connected to a pull mechanism 42 which operatively controls the reciprocation of the stopper rod 38 manually or under automatic computer control.

The crucible 22 and stopper rod 38 are preferably constructed of an inert material to minimize any impurities that might otherwise be imparted to the molten silicon.

A source of pressurized inert gas, such as argon, is fluidly connected to the air space within the crucible 22 above the fluid level of the liquid silicon such as by means of a conduit 44 extending through the lid 22L of the crucible 22. The pressurization of the inert gas going through the conduit 44 into the air space within the crucible 22 is set at a desired pressure relative to the viscosity of the liquid silicon in the crucible 22 so as to achieve a desired flow rate of the silicon through the nozzle 34 onto the peripheral surface 24 of the rotating drum 12.

Returning to FIG. 1, the rotating drum 12 may be passively cooled by incorporating a plurality of vents 46 through its end plates sufficient to allow venting and therefore cooling of the peripheral surface 24 of drum 12. Alternatively, or in combination, the peripheral surface 24 of the drum 12 may be actively cooled by directing a cooler fluid, such as cooler gas or liquid fluid (e.g., cooling air flow or a flow of cooling water, or other gas or fluid), into drum 12 to thereby cool the peripheral surface 24 of the drum 12.

It is contemplated that the peripheral surface 24 and the rotating drum 12 may constitute a smooth surface; however, preferably the surface 24 is textured to better control the heat transfer between the silicon strip and the peripheral surface 24 as it is dispensed from the crucible 22. It is also contemplated that peripheral surface 24 of the rotating drum 12 should be cleaned after the silicon strip is peeled from the peripheral surface 24 by means of the air knife 26. Accordingly, a rotating brush 48, preferably rotating in counter-rotation to the drum 12, may be operatively positioned in engagement with the peripheral surface 24 at a point downstream of the air knife 26.

The operating parameters of the bench modeling of the continuous cast silicon strip apparatus and method 10 of the invention as presently contemplated include:

Drum:
Speed: 0˜2 RPS
DIA: 1 m
Width: 20 cm
Tolerance: at 100 μm±12 μm or better
   0.004″±0.0005″
Material: Cu, Cu-10.Cr, Cu—Be or Steel

Cast Strip:
Size: 0.1 mm×50 mm (wide)
Vol.=w×t×l or 5 cm×0.01 cm×L=0.05 cm²L
1 kg: 1000 g/2.33 g/μm³=429 cm³=0.05 μm²L
L=8580 cm>>85.8 m

Silicon:
Tmp=1410° C.
Density=2.33 g/cm³
H_{f}=432 cal/gm
Cp=5.74+0.617×10⁻³ t−1.01×10⁵/t² t=° K

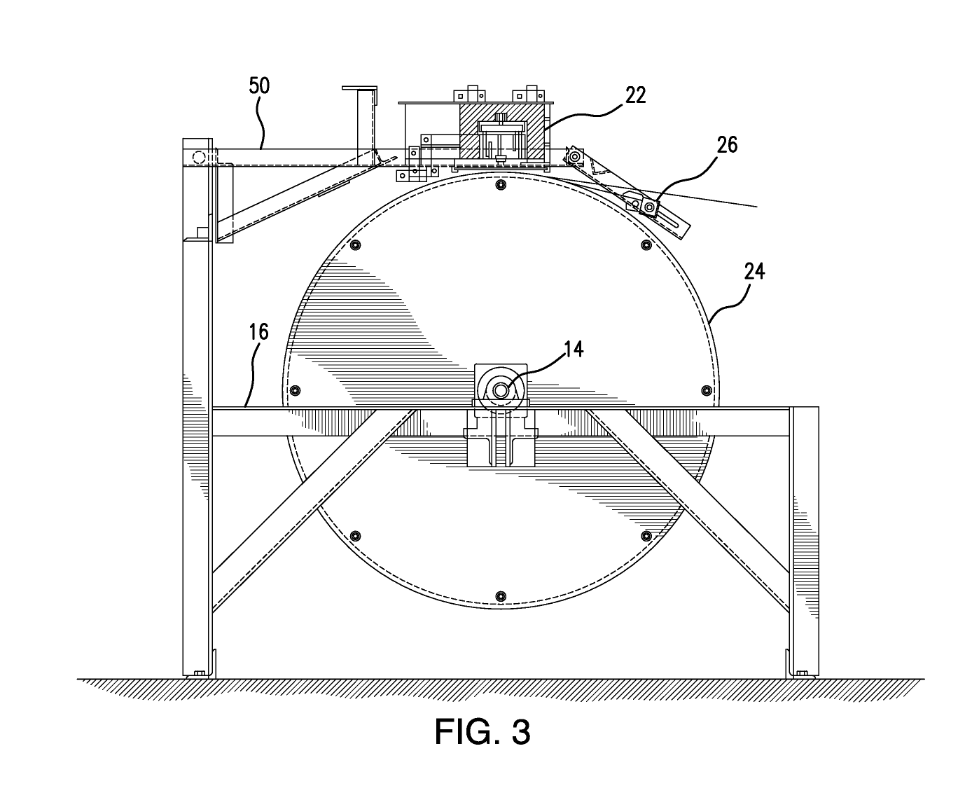

As shown in FIG. 3, the crucible 22 is preferably positioned above the peripheral surface 24 of the rotating drum 12 by means of a cantilever arm 50 which is adjustable laterally and vertically to assure that the longitudinal axis of the slot 36 of the nozzle 34 of the dispenser 32 is in perpendicular alignment with the peripheral surface 24 of the rotating drum 12 and to adjustably control the spacing between the slot 36 and the peripheral surface 24 such that the silicon strip being dispensed onto the peripheral surface 24 is of the desired thickness. The cantilever arm 50 may also serve as a support for the air knife 26 so as to adjustably position the air knife 26 relative to the peripheral surface 24 by an appropriate spacing to assure that the vent of air from the air knife 26 is directed at an appropriate angle to cause peeling of the silicon strip from the peripheral surface 24 whereupon it may then go onto a conveyor 28.

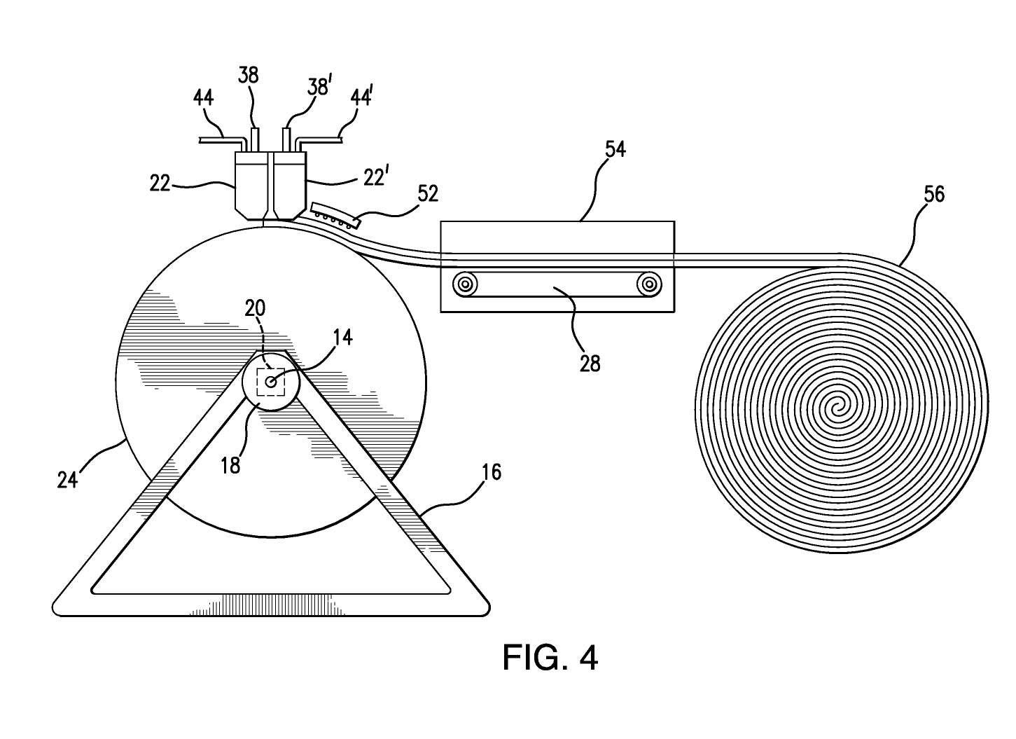

Referring to FIG. 4, the above-described apparatus and method may utilize two crucibles 22 and 22′, each filled with a differently-doped silicon (e.g., one p-type and the other n-type), to continuously form another strip of silicon (e.g. p-type silicon) directly onto the first strip (e.g., n-type silicon) to form a dual layer strip functioning as a pn junction.

As also shown in FIG. 4, it is contemplated that in order to increase the heat transfer between the silicon strip and the peripheral surface 24 prior to peeling, a means for urging the silicon strip into contiguous engagement with the peripheral surface 24 may be provided. The urging means preferably comprises an air jet 52 mounted proximate to the peripheral surface (e.g., onto the cantilever arm 50); however, a mechanical roller or other device may be utilized (not shown).

The resulting single-layer silicon strip (FIGS. 1-3) and the dual-layer strip (FIG. 4) may pass through an annealing chamber 54 to then be rolled up onto a take-up wheel 56 for storage until needed for subsequent segmenting into individual cells.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A continuous cast silicon strip apparatus comprising in combination:
a drum rotatably mounted on an axle supported by a framework;
a motor operatively connected to said axle to cause rotation of said drum about said axle;
a crucible mounted relative to said drum to dispense liquid silicon onto a peripheral surface of said drum as said drum rotates to continuously cast a silicon strip onto said peripheral surface; and
a segmenting mechanism for segmenting said continuous cast silicon strip into silicon segments having a desired length.

2. The apparatus as set forth in claim 1, wherein said crucible comprises:
an air knife mechanism operatively positioned downstream relative to said continuous cast silicon strip to peel said continuous cast silicon strip from said peripheral surface of said drum; and
a conveyor positioned relative to said air knife mechanism to receive said continuous cast silicon strip thereon.

3. The apparatus as set forth in claim 1, wherein said crucible comprises:
a generally rectangular configuration having a desired interior volume;
a lid fitted about an open end of said crucible; and
an induction heater in heat-exchanging relationship with said crucible to heat said crucible to a desired operating temperature to achieve a desired liquid viscosity of said silicon therein.

4. The apparatus as set forth in claim 2, wherein said crucible further comprises a dispenser operatively positioned in a bottommost portion of said crucible.

5. The apparatus as set forth in claim 3, wherein said dispenser comprises a nozzle having an elongated slot formed therethrough through which the liquid silicon in said crucible is dispensed onto said peripheral surface of said rotating drum.

6. The apparatus as set forth in claim 4, further comprising a reciprocating stopper rod for interrupting flow through said slot.

7. The apparatus as set forth in claim 5, wherein said stopper rod comprises a tip configured and dimensioned to form a seal with said slot to prevent flow therethrough while seated therein.

8. The apparatus as set forth in claim 6, wherein said stopper rod is operatively connected to a pull mechanism which operatively controls the reciprocation of said stopper rod manually or under automatic computer control.

9. The apparatus as set forth in claim 7, wherein said crucible and said stopper rod are constructed of an inert material to minimize any impurities that might otherwise be imparted to said liquid silicon.

10. The apparatus as set forth in claim 3, further comprising a source of pressurized inert gas fluidly connected to air space within said crucible above the fluid level of said liquid silicon therein.

11. The apparatus as set forth in claim 9, wherein said source of pressurized inert gas is fluidly connected to said air space by a conduit extending through said lid of said crucible.

12. The apparatus as set forth in claim 10, wherein said source of pressurized inert gas comprises a pressure relative to the viscosity of said liquid silicon in said crucible to achieve a desired flow rate of said silicon onto said peripheral surface of said rotating drum.

13. The apparatus as set forth in claim 3, further including at least one vent formed in an end said drum to allow venting and therefore cooling of said peripheral surface of said drum.

14. The apparatus as set forth in claim 3, further including a source of cooler fluid fluidly connected to said peripheral surface of said drum.

15. The apparatus as set forth in claim 3, wherein said peripheral surface of said rotating drum comprises a smooth surface.

16. The apparatus as set forth in claim 3, wherein said peripheral surface of said rotating drum comprises a textured surface

17. The apparatus as set forth in claim 3, further including a rotating brush operatively positioned in engagement with said peripheral surface downstream of said air knife.

18. The apparatus as set forth in claim 16, wherein said rotating brush rotates in counter-rotation to said drum.

19. The apparatus as set forth in claim 4, wherein said crucible is positioned above said peripheral surface of said rotating drum by a cantilever arm.

20. The apparatus as set forth in claim 18, wherein said cantilever arm is adjustable laterally and vertically to assure that a longitudinal axis of said slot of said nozzle of said dispenser is in perpendicular alignment with said peripheral surface of said rotating drum and to adjustably control the spacing between said slot and said peripheral surface such that said silicon strip being dispensed onto said peripheral surface is of the desired thickness.

21. The apparatus as set forth in claim 19, wherein said cantilever arm adjustably positions said air knife relative to said peripheral surface by an appropriate spacing to assure that the air from said air knife is directed at an appropriate angle to cause peeling of said silicon strip from said peripheral surface.

22. The apparatus as set forth in claim 1, further comprising at least two of said crucibles, each filled with differently-doped silicon to continuously form one strip of silicon directly onto the other strip of silicon, thereby forming a dual layer strip functioning as a semiconductor junction.

23. The apparatus as set forth in claim 1, further including mechanism for urging said silicon strip into contiguous engagement with said peripheral surface, thereby increasing the heat transfer between said silicon strip and said peripheral surface prior to peeling.

24. The apparatus as set forth in claim 22, wherein said urging mechanism comprises an air jet mounted proximate to said peripheral surface.

25. The apparatus as set forth in claim 22, wherein said urging mechanism comprises a mechanical roller.

26. The apparatus as set forth in claim 1, further including an annealing chamber through which said silicon strip, thereby annealing said silicon strip.

27. The apparatus as set forth in claim 25, wherein said annealing chamber is positioned relative to said conveyor such that said annealed silicon strip is rolled onto a take-up wheel for temporary storage whereupon said silicon strip is then unrolled and passed through said segmenting mechanism for segmenting into said individual cells
